(19) United States
(12) Patent Application Publication
(10) Pub. No.: US 2021/0365554 A1
(43) Pub. Date: Nov. 25, 2021

(54) SECURING COMPUTING SYSTEMS AGAINST MICROARCHITECTURAL REPLAY ATTACKS

(71) Applicant: ETA SCALE AB, Uppsala (SE)

(72) Inventors: Christos SAKALIS, Uppsala (SE); Stefanos KAXIRAS, Uppsala (SE); Magnus SJÄLANDER, Ostersund (SE)

(21) Appl. No.: 17/329,596

(22) Filed: May 25, 2021

Related U.S. Application Data
(60) Provisional application No. 63/160,193, filed on Mar. 12, 2021.
(60) Provisional application No. 63/029,580, filed on May 25, 2020.

(51) Int. Cl. G06F 21/55; G06F 21/54; G06F 9/32; G06F 9/38

(52) U.S. Cl. CPC G06F 21/556; G06F 9/3855; G06F 9/321; G06F 21/54

(57) ABSTRACT

A system and method for mitigating micro-architectural replay attacks in a processing system by delaying speculative execution on the processing system of a set of processor instructions upon detection that the set of processor instructions are part of a micro-architectural replay attack by detecting repeating speculative execution of the set of processor instructions interleaved with misspeculation and squashing of the set of processor instructions.

### CROSS-REFERENCE TO RELATED APPLICATIONS

The present application is related to, and claims priority from, U.S. Provisional Patent Application 63/029,580, filed May 25, 2020, entitled “System and Method for Securing Computing Systems Against Microarchitectural Replay Attacks” to Christos Sakalis, Stefanos Kaxiras, and Magnus Själander (Sjalander) and U.S. Provisional Patent Application No. 63/160,193, filed Mar. 12, 2021, entitled “System and Method to Protect Against Microarchitectural Replay Attacks” to Christos Sakalis, Stefanos Kaxiras, and Magnus Själander (Sjalander), the entire disclosures of which are incorporated herein by reference.

### TECHNICAL FIELD

Embodiments described herein relate in general to computer security and, more particularly, to microarchitectural replay attacks.

### BACKGROUND

Rising concerns about privacy and security in the modern digital world create an increased interest in hardware trusted execution environments, which are also known as secure enclaves, from computer architects, software developers, and security researchers. Secure enclaves provide hardware enforced security guarantees that protect the enclaved code from outside interference, including interference from the operating system (OS) or other untrusted hardware. This is achieved through a variety of security measures such as memory encryption and attestation.

Even though the enclave is configured to prevent malicious system components from directly interfering with the enclaved code, numerous attacks are still made possible through side-channels, exploiting architectural and microarchitectural behavior of the system in unintended ways to create covert communication channels and leak secret information, e.g., Zombieload as described by M. Schwarz et al. in “ZombieLoad: Cross-Privilege-Boundary Data Sampling”, Proceedings of the ACM SIGSAC Conference on Computer & Communications Security, London, United Kingdom: Association for Computing Machinery, November 2019, pp. 753-768, and TL-Bleed as described by B. Gras et al. in “Translation leak-aside buffer: Defeating cache side-channel protections with TLB attacks”, USENIX Association, Baltimore, Md.: USENIX Association, August 2018, pp. 955-972.

Secure enclaves remain effective, as side-channels are typically very noisy communication channels and often require several iterations of the same attack before being able to leak any information reliably. While cases where the attacker is targeting specific immutable data and the enclaved code can be arbitrarily triggered, e.g., to encrypt some data, can be imagined, in many cases, e.g., SGX implementations of Tor as described in S. Kim et al., “SGX-Tor: A Secure and Practical Tor Anonymity Network With SGX Enclaves”, IEEE/ACM Transactions on Networking, vol. 26, no. 5, pp. 2174-2187, October 2018, and “The Tor project”, https://www.torproject.org/., secure database implementations, and systems secured against rollbacks as described in S. Matetic et al., “ROTE: Rollback protection for trusted execution,” in Proceedings of the USENIX Security Symposium, 2017, pp. 1289-1306, the attacker targets transient execution data, e.g., Tor traffic, and only has one opportunity to perform the attack and leak information. In these cases, the majority of the available side-channels are not effective, as it is not possible to distinguish a single iteration of the attack from system noise.

Microarchitectural side-channel attacks in general take advantage of the microarchitectural state (p-state) of modern central processing units (CPUs) to transfer and leak information under conditions where it is not possible to do so on the architectural level. For example, cache side-channels take advantage of the difference in timing between a hit or a miss in the cache to encode information, as described in Y. Lyu et al., “A Survey of Side-Channel Attacks on Caches and Countermeasures,” Journal of Hardware and Systems Security, vol. 2, no. 1, pp. 33-50, March 2018, D. A. Osvik et al., “Cache attacks and countermeasures: the case of AES,” in Proceedings of the RSA Conference. Berlin, Heidelberg: Springer, 2006, pp. 1-20 and Y. Yarom et al., “FLUSH₊ RELOAD: A high resolution, low noise, I3 cache side-channel attack,” in Proceedings of the USENIX Security Symposium. Berkeley, Calif., USA: USENIX Association, 2014, pp. 719-732, by indirectly manipulating and probing the state of the cache through normal memory operations.

Similar timing side-channels can also be constructed in other parts of the system as well, Q. Ge et al., “A survey of microarchitectural timing attacks and countermeasures on contemporary hardware,” Journal of Cryptographic Engineering, vol. 8, no. 1, pp. 1-27, April 2018, such as by utilizing functional unit (FU) contention. Finally, non-timing side-channels are also possible, exploiting side-effects of the execution such as power consumption P. Kocher et al., “Differential power analysis,” in Proceedings of the Annual International Cryptology Conference. Springer, 1999, pp. 388-397, or EMF radiation, K. Gandolfi et al., “Electromagnetic analysis: Concrete results,” in Proceedings of the International Workshop on Cryptographic Hardware and Embedded Systems. Springer, 2001, pp. 251-261.

As these side-channels are not purposely configured communication channels but rather side-effects of the normal architectural and microarchitectural behavior of the system, they are inherently noisy and unreliable. For example, when using a cache-based side-channel, there is nothing to prevent the cacheline(s) being used for the side-channel from being evicted by a third process in the system. Similarly, interrupts, context switches, and other interruptions in the program execution can also disrupt the side-channel. There are also no architectural mechanisms provided for synchronizing the transmitter and the receiver during side-channel operations, which then have to be constructed using the side-channel itself or other mechanisms.

All these issues make exploiting side-channels harder, but not impossible. Similar to how modern communication protocols are configured with the underlying channel characteristics in mind, protocols for side-channels can be configured. For example, noise on a side-channel can be filtered out using error detection and correction codes, combined with statistical methods. Maurice et al., “Hello from the other side: SSH over robust cache covert channels in the cloud,” Proceedings of the Network and Distributed System Security Symposium, 2017, have presented one such protocol where they were able to implement ssh communications over a cache-based side-channel. As many of the underlying issues can be resolved by simply repeating the transmission of information through the side-channel until successful, whether a side-channel can be practically exploited becomes a function of the delay between each retransmission, i.e., how fast can the side-channel be rerun, and the average number of retransmissions necessary, i.e., how many times does the side-channel have to be run.

Under the conditions described by Maurice et al., both the transmitter and the receiver (both of which are programs) are under the full control of the attacker. This enables the attacker to not only control when the side-channel transmission takes place, to better synchronize the transmitter and the receiver, but also to repeat the transmission as many times as necessary. However, this is not always the case. For example, sometimes the transmitter is not a purposely designed application but a targeted victim, such as a cryptographic application. The attacker then uses side-channels to monitor the behavior of the application under normal execution and to infer, for example, the cryptographic keys. In some cases the attacker is able to either directly execute or trigger the execution of the victim application at will, repeating as many times as necessary to extract the keys. This ability to replay the victim code multiple times is crucial in being able to reliably exploit the utilized side-channel, due to the issues already discussed.

MicroScope, and microarchitectural replay attacks in general, introduced by and described in Skarlatos et al., “MicroScope: Enabling Microarchitectural Replay Attacks”, Proceedings of the International Symposium on Computer Architecture, ser. ISCA '19, New York, N.Y., USA: ACM, 2019, pp. 318-331, enable an attacker to “trap” the execution of an enclaved application and force the enclaved application to re-execute specific regions of code ad infinitum. With MicroScope, this is achieved by abusing a combination of speculative execution and page fault handling in cases where the latter is still delegated to the (malicious/compromised) OS. Under typical execution, whether the code is executed in an enclave or not, if an address translation misses in the translation lookaside buffer (TLB) a page table walk is triggered. During the page table walk, the application continues executing speculatively, as long as the instructions do not depend on the faulting memory instruction.

If during the page table walk it is determined that the page is not available and that the OS needs to be invoked, then the speculatively executed instructions are squashed and execution restarts from the faulting instruction. At the time the execution restarts, another page table walk might be needed as the address translation still does not exist in the TLB. However, since the operating system has now mapped the page, the page table walk typically succeeds.

MicroScope takes advantage of this behavior by having the OS signal that it has mapped the page without actually mapping the page. This traps the victim application in a loop where a memory instruction misses in the TLB, triggers a page table walk and continues executing speculatively, triggers a page fault, squashes the speculatively executed instructions, re-executes the faulting instruction and misses in the TLB again. By triggering these loops at specific parts of the code, e.g., just before the instructions that trigger the side-channel information leakage, the attacker can repeat the side-channel until all the underlying noise can be filtered out, making even the least reliable side-channels possible.

Therefore, a need exists for protecting processing systems from side channels attacks that utilize microarchitectural replay attacks.

### SUMMARY

Exemplary embodiments are directed to solving or preventing microarchitectural replay attacks in general by expanding from re-execution brought on by page faults to re-execution brought on by any form of speculation in modern processing systems such as computing systems. In addition, exemplary embodiments are applicable to cases where a given processor instruction that can cause misspeculation and squashing of the set of processor instructions, referred to as a handle or dynamic instruction, cannot by itself trigger a large number of re-executions, by introducing a method that utilizes multiple handles or dynamic instructions. Speculative execution of processor instructions is delayed upon detection of a squash, which is referred to as Delay-on-Squash. Exemplary embodiments transparently provide protection, in hardware, for microarchitectural replay attacks including MicroScope attacks, while avoiding significant impact on performance, energy, area, in the processing system and implementation complexity.

The speculative execution of instructions is selectively delayed when it is determined the speculative execution of processor instructions might be used as part of a microarchitectural replay attack. If an attack requires microarchitectural replay to be successful, repeating speculation of a set of processor instructions interleaved with misspeculation and squashing of the set of processor instructions is restricted. Exemplary embodiments engage one or more levels of speculative defense mechanisms, for example, in one level, only certain processor instructions are delayed, for example, only persistent microarchitectural state side channel instructions. An example of this level of speculative defense mechanism is Delay-on-Miss, which is described herein. In another level, which is a much stricter speculative delay mechanism, all speculative execution or the speculative execution of all side channel instructions is delayed. This stricter speculative delay mechanism can be referred to as a Delay-All mechanism. Other levels of delay, include delaying the speculative execution of instructions whose operands are speculatively accessed values or values that were generated from speculatively accessed values from the memory hierarchy and delaying the speculative execution of instructions with memory fence or memory barrier instructions. These various levels of speculative defense are triggered once a certain threshold of repeated misspeculation has been reached. This threshold is possible to track in the hardware and is fully adjusted for Delay-on-Miss, Delay-All, and other levels of delay to fit the different security and performance requirements of each system.

Other exemplary embodiments utilize at least one squashed processor instruction database to store an identification, e.g., program counters from a reorder buffer, of squashed processor instructions. In one embodiment, each squashed instruction database utilizes hash values of the program counters. For example, each squashed processor instruction database is a Bloom filter. Only processor instructions not contained in the squashed processor instruction database can be executed.

Exemplary embodiments are direct to a method for mitigating micro-architectural replay attacks in a processing system by delaying speculative execution on the processing system of a set of processor instructions, including side channel instructions, upon detection that the set of processor instructions are part of a micro-architectural replay attack. This includes detecting repeating speculative execution of the set of processor instructions interleaved with misspeculation and squashing of the set of processor instructions.

In one embodiment, a reorder buffer containing the set of processor instructions is maintained. The set of processor instructions includes side channel instructions and dynamic instructions that can cause misspeculation and squashing of the set of processor instructions, and each processor instruction in the set of processor instructions has an associated unique program counter in the reorder buffer. The program counter for each dynamic instruction in the reorder buffer is placed in a handle queue.

In one embodiment, the set of processor instructions in the reorder buffer includes squashed processor instructions, and delaying speculative execution includes storing program counters for the squashed processor instructions in at least one squashed processor instruction database and tagging the at least one squashed processor instruction database with a youngest dynamic instruction from the reorder buffer at a time when the program counters are stored. In one embodiment, the program counters are stored as hash values of the program counters. In one embodiment, the at least one squashed processor instruction database is a Bloom filter.

In one embodiment, program counters for the squashed processor instructions are stored in two squashed processor instruction databases. At a given time, one squashed processor instruction database is designated as an active squashed processor instruction database, and one squashed processor instruction database is designated as an inactive squashed processor instruction database. Upon detection of an additional squash, program counters associated with squashed processor instructions in the additional squash are inserted into the active squashed processor instruction database. The squashed processor instruction databases are periodically switched between the active squashed processor instruction database and the inactive squashed processor instruction database.

In one embodiment, the program counters in a given squashed processor database are cleared no earlier than a resolution of a speculative status of all dynamic instructions in the reorder buffer older than the youngest dynamic instruction tagging the given active squashed processor database to non-speculative status. In one embodiment, only processor instructions not contained in any squashed processor instruction database are executed.

In one embodiment, delaying speculative execution further includes identifying a threshold number of squashes of the set processor instructions before initiating a given level of delay in speculative execution of the set of processor instructions, maintaining a counter of a number of squashes of the set of processor instructions, detecting a new misspeculation and squashing of the set of processor instructions, incrementing the counter, and initiating the given level of delay in the speculative execution of the set of processor instructions when the counter is equal to or greater than the threshold.

In one embodiment, identifying the threshold number of squashes includes identifying a first threshold for a first level of delay and identifying a second threshold for a second level of delay. In one embodiment, the second level of delay is stricter than the first level of delay. A first level of delay is initiated when the counter is equal to or greater than the first threshold and less than the second threshold, and the second level of delay is initiated when the counter is equal to or greater than the second threshold. In one embodiment, the first level of delay delays only persistent microarchitectural state side channel instructions, and the second level of delay delays all side channel instructions.

In one embodiment, delaying speculative execution includes determining that a given dynamic instruction in the dynamic instructions in the reorder buffer is non-speculative by determining that the given dynamic instruction cannot cause misspeculation and squashing of any other processor instruction in the set of processor instructions and that the given dynamic instruction cannot be squashed by any other dynamic instruction in the reorder buffer.

Exemplary embodiments are also directed to a processing system capable of mitigating micro-architectural replay attacks in the processing system. The processing system includes a processor to execute processor instructions from a computer program executing on the processing system and a reorder buffer. The reorder buffer contains a set of processor instructions. The set of processor instructions includes side channel instructions and dynamic instructions that can cause misspeculation and squashing of the set of processor instructions. Each processor instruction in the set of processor instructions has an associated unique program counter in the reorder buffer.

The processing system includes a handle queue in communication with the processor. The handle queue contains the program counter for each dynamic instruction in the reorder buffer. At least one squashed processor instruction database is provided for storing program counters for squashed processor instructions in the reorder buffer, and the processor only executes processor instructions not contained in the squashed processor instruction database to delay speculative execution on the processing system of the set of processor instructions upon detection that the set of processor instructions are part of a micro-architectural replay attack.

In one embodiment, the at least one squashed processor instruction database is a Bloom filter. In one embodiment, the processing system includes two squashed processor instruction databases, an active squashed processor instruction database and an inactive squashed processor instruction database. Program counters associated with processor instructions in the reorder buffer that have been squashed are inserted into the active squashed processor instruction database upon detection of a squash. The squashed processor instruction databases are switch between the active squashed processor instruction database and the inactive squashed processor instruction database periodically.

In one embodiment, the active squashed processor database and the inactive squashed processor database are each tagged with a dynamic instruction from the reorder buffer representing a youngest dynamic instruction in the reorder buffer any time program counters are stored. The program counters in a given squashed processor database are cleared no earlier than a resolution of a speculative status of all dynamic instructions in the reorder buffer older than the youngest dynamic instruction tagging the given active squashed processor database to non-speculative status, and the processor instructions associated with the cleared program counters are executed.

Exemplary embodiments are also directed to a processing system capable of mitigating micro-architectural replay attacks in the processing system. The processing system includes a processor to execute processor instructions from a computer program executing on the processing system and a reorder buffer. The reorder buffer contains a set of processor instructions including side channel instructions and dynamic instructions that can cause misspeculation and squashing of the set of processor instructions. Each processor instruction in the set of processor instructions has an associated unique program counter in the reorder buffer.

The processing system includes a handle queue in communication with the processor, and a counter containing a number of squashes of the set of processor instructions that have occurred. The handle queue contains the program counter for each dynamic instruction in the reorder buffer, and the counter is incremented upon detection of a new misspeculation and squashing of the set of processor instructions. A given level of delay in the speculative execution of the set of processor instructions is initiated when the counter is equal to or greater than a predefined threshold to delay speculative execution on the processing system of the set of processor instructions upon detection that the set of processor instructions are part of a micro-architectural replay attack.

In one embodiment, a first level of delay is initiated when the counter is equal to or greater than a first threshold and less than the second threshold and a second level of delay is initiated when the counter is equal to or greater than a second threshold. The second threshold is greater than the first threshold, and the second level of delay is stricter than the first level of delay. In one embodiment, the processing system includes a youngest unresolved dynamic instruction register containing a uniquely identifying dynamic instance of the program counter associated with a youngest dynamic instruction in the handle queue.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1A is an illustration of an embodiment of a single handle microarchitectural replay attack pattern;

FIG. 1B is an illustration of an embodiment of a serial handle microarchitectural replay attack pattern;

FIG. 1C is an illustration of an embodiment of a nested handle microarchitectural replay attack pattern;

FIG. 2 is an illustration of an embodiment of execution behavior of a microarchitectural replay attack;

FIG. 3 is an embodiment of code that can be executed to produce two handles;

FIG. 4 is an illustrated of an embodiment of a method for mitigating micro-architectural replay attacks in a processing system;

FIG. 5 is another embodiment of code that can be executed to produce two handles;

FIG. 6 is an illustrated of another embodiment of a method for mitigating micro-architectural replay attacks in a processing system;

FIG. 7 is a schematic representation of an embodiment of a processing system capable of mitigating micro-architectural replay attacks in the processing system;

FIG. 8 is a flow chart illustrating an embodiment of a method for mitigating micro-architectural replay attacks in a processing system;

FIG. 9 is a flow chart illustrating an embodiment of delaying speculative execution of processor instructions in accordance with a level of delay; and

FIG. 10 is a flow chart illustrating another embodiment of delaying speculative execution of processor instructions in accordance with a level of delay.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. Some of the following embodiments are discussed, for simplicity, with regard to exemplary configurations. However, the embodiments to be discussed next are not limited to these configurations, but may be extended to other arrangements as discussed later.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to various embodiments, systems and methods are disclosed for preventing side-channel attacks on computing systems such as those utilizing microarchitectural replay attacks. Microarchitectural replay attacks, e.g., Microscope, are not by themselves a side-channel attack. Instead, microarchitectural replay attacks are a tool to amplify the effects of side-channel attacks, enabling the attacker to mount a successful attack under conditions where it would not otherwise be possible. Therefore, microarchitectural replay allows even the smallest, most innocuous amount of information leakage to be amplified and abused.

Many modern CPUs offer secure execution contexts referred to as trusted execution environments (sometimes also referred to as “secure enclaves”) that protect the executed code from outside interference, including interference from the operating system (OS) or the hypervisor. The characteristics of these enclaves differ for each architecture but can include encrypted memory for applications running in the enclave, code verification to prevent malicious code from being executed in the enclave, and hardware-enforced isolation of the enclaved execution context from any other execution context in the system, including the OS. These measures are meant to protect sensitive code and data, such as cryptographic functions and their keys, from any attacker that might have compromised other parts of the system, including the OS or the hypervisor. Microscope microarchitectural replay attacks target this case, focusing specifically on Intel's Secure Guard Extensions (SGX) enclave as a use case, although the underlying exploitable concept is not limited to SGX. These microarchitectural replay attacks exploit the fact that under SGX the page management of the application is still delegated to the OS, which is considered secure because the memory accessed under SGX execution is cryptographically encrypted and verified, preventing even the OS from accessing or manipulating it, to capture the execution of the application and force the application to be re-executed as many times as necessary for the side-channel attack to be successful. In particular, these microarchitectural replay attacks take advantage of how page faults are handled during execution and of the speculative out-of-order capabilities of modern CPUs.

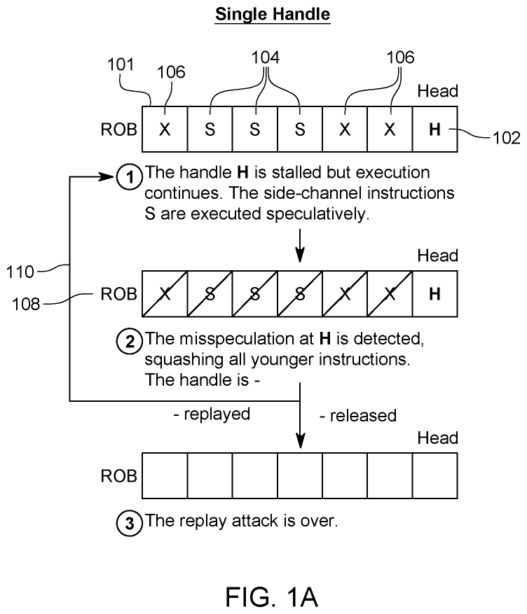

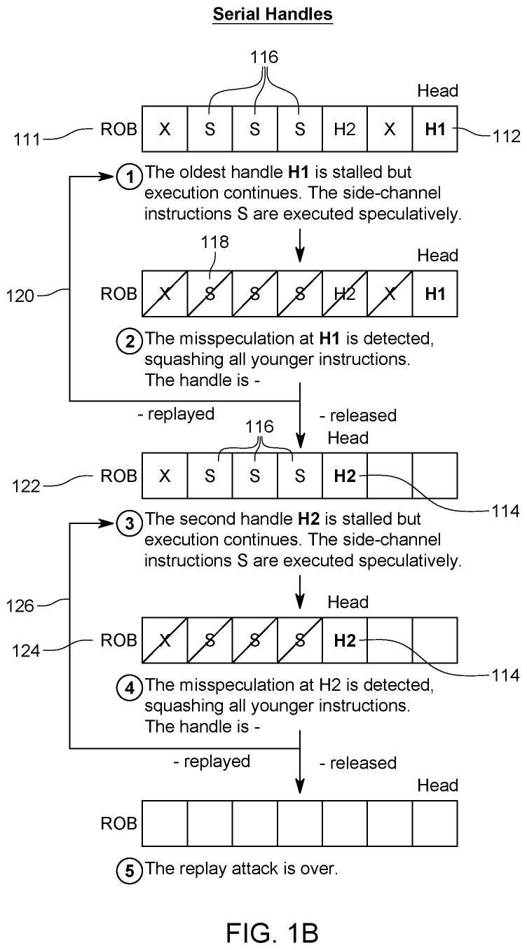

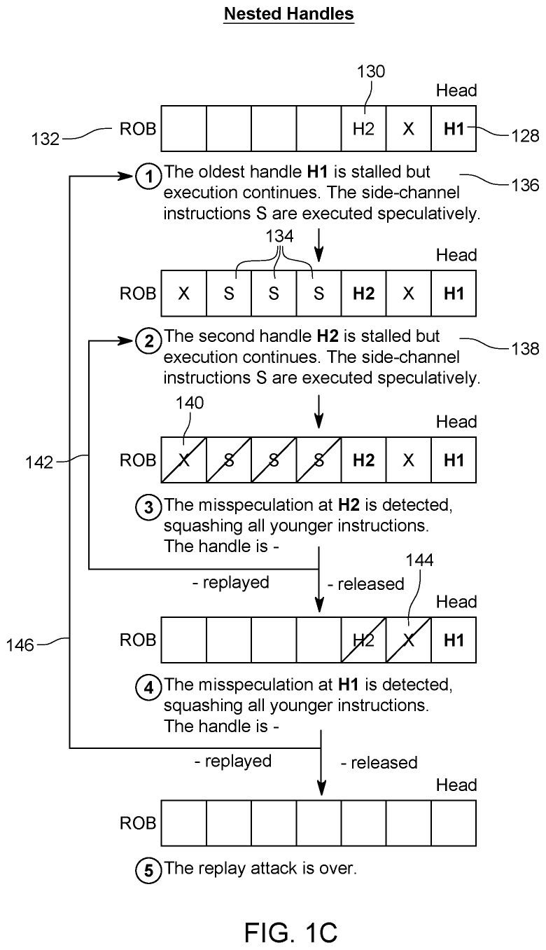

Referring initially to FIGS. 1A-C, three different microarchitectural replay attack patterns are illustrated. These microarchitectural replay attack patterns include Single Handle in FIG. 1A, Serial Handles in FIG. 1B, and Nested Handles in FIG. 1C. During a Microscope microarchitectural replay attack, for example, the OS manipulates the page table of the victim application to ensure that a processor instruction causes misspeculation and squashing of a set of processor instructions. These processor instructions are referred to herein as dynamic instructions or handles. For example, in one embodiment, the processor instruction is a load instruction that will cause a page fault. This load instruction is referred to as a handle, and the operation is referred to as “acquiring a handle”. The OS and the page table misspeculation is just one example of a possible handle for a microarchitectural replay attack, and other handles can be used.

The processor system includes a reorder buffer that stores a set of processor instructions to be executed by the processor on the processing system. Suitable processor instructions include, but are not limited to, processor instructions that can cause misspeculation and squashing of other processor instructions, referred to as replay handles or handles 102 and designated with an ‘H’, side-channel instructions 104 which are designated with an ‘S’, and other types of processor instructions 106 that are not specific to the microarchitectural replay side-channel attack and are designated with an ‘X’.

The victim application running on the processor system executes the processor instructions in the reorder buffer. When the application reaches a handle 102 speculative execution of processor instructions is initiated. For example, a TLB miss occurs, and a page walk is triggered. During the page walk, it takes time before the page fault is resolved, and during that time execution of the victim application and the processor instructions in the reorder buffer continues speculatively. While executing speculatively, the victim application performs the processor instructions 104,106 that follow the load instruction 102 that causes the page fault, i.e., the handle, as long as those instruction are not dependent on the value of the load instruction. For Microscope microarchitectural replay attacks in particular, the handle is selected so that the instructions that are speculatively executed following the page fault include side-channel instructions 104 that unwillingly form the transmitter for the side-channel. While the victim application is executing the side-channel instructions, the page walker concludes that the page is not mapped and triggers a page fault, delegating the page handling to the OS. This causes all the instructions after the load, including the transmission code that has already been executed once speculatively, to be squashed and to be re-executed or replayed 108.

The OS updates the page table and invalidates the relevant TLB entries, signaling the victim application that the load is ready to be executed. However, the OS does this in a way that ensures that the handle will page fault again, and execution restarts 110. By repeating this procedure, the OS keeps the victim application in a speculative loop, where the handle 102 keeps faulting, causing the instructions that follow it, i.e., the transmission code, to be speculatively executed again and again. The only way for the loop to be broken is for the attacker to release the handle, allowing the victim application to successfully service the TLB miss.

Using the speculative execution mechanism of squashing and re-executing, microarchitectural replay attacks trap the execution of the victim application in a loop for an arbitrary number of iterations until the attacker can reliably denoise the side-channel. In one embodiment, the receiver is a typical side-channel receiver trying to detect the side-effects caused by the transmitter, such as changes in the cache or FU contention, with the addition that since the attacker can control the execution of the program on a fine-grained level, it is possible to fully synchronize the transmitter with the receiver.

Referring to FIG. 1B, more than one handle can be used in the reorder buffer 111, a first handle 112 and a second handle 114. The two handles are configured as serial handles, and the attacker releases the first handle and acquires a second one, which is located within the reorder buffer in the short region of code between the first handle and the side-channel instructions 116. Using multiple handles in this way can be abused by yet unknown attacks.

In the short amount of time since Spectre, P. Kocher et al., “Spectre Attacks: Exploiting Speculative Execution”, Proceedings of the IEEE Symposium on Security and Privacy. Washington, D.C., USA: IEEE Computer Society, May 2019, pp. 19-37, and Meltdown, M. Lipp et al., “Meltdown”, January 2018, were introduced, attacks that abuse speculative execution in new and imaginative ways have increased. One common theme behind all these attacks is an underestimation of how imaginative security researchers and malicious attackers can be. This is what lead to Spectre and Meltdown in the first place, as well as all the other attacks that followed. Similarly, microarchitectural replay attacks exploit page faults and a specific behavior found in some secure enclaves (delegating page faults to the OS). However, this is not the only behavior that can be exploited. Generalizations of microarchitectural replay attacks include other reasons for misspeculation, as well as how multiple handles can potentially be abused in creative ways to trap the execution of the program, for the cases where it is not possible for the attacker to keep a handle indefinitely.

Under microarchitectural replay attacks, in one embodiment a single instruction that causes a page fault is used as the handle to replay a set of instructions indefinitely as illustrated in FIG. 1A. This is possible because (i) page faults are a specific type of misspeculation that can be repeated indefinitely, and (ii) there is nothing in the architecture that prevents an instruction from misspeculating several times in a row. However, other forms of speculation can be used as handles, including, but not limited to, branch prediction or even transactional memory. Transactional memory is not necessarily implemented as traditional speculative execution, confined within the reorder buffer (ROB), but it does have similar characteristics, neither of which can be repeated indefinitely. Once a branch has been executed, the correct path is known, and the same instruction (dynamic instruction in the ROB) will not be mispredicted a second time. Similarly, transactions usually abort after a number of tries, at which point the transactions follow a fallback path. When multiple handles are used, the handles can be the same type of handle or different types of handles.

Using the first handle 112 and the second handle 114 arranged as a serial handles within the ROB 111 as in FIG. 1B, an attacker extends the duration of the microarchitectural replay attack for each case, in particular for handles of different types that are used together. When the first handle 112 is stalled, speculative execution of the processor instructions after the first handle execution continues, including the side-channel instructions 116. Upon detection of misspeculation at the first handle, all processor instructions younger than the first handle are squashed. For a microarchitectural replay attack, execution would restart 120, and the first handle would be replayed.

If the system restricts the number of times each dynamic instruction or handle is allowed to misspeculate and then be re-executed speculatively, e.g., as a simple but naïve solution to microarchitectural replay attacks, then execution of the first handle would not restart. While the first handle would be released from the ROB, the second handle remains and is stalled while execution of the processor instructions in the ROB younger than the second handle continues. The side-channel instructions 116 are again executed speculatively 122. Upon detection of the misspeculation at the second handle, all processing instructions younger than the second handle are squashed 124. The second handle can then be replayed 126, continuing the microarchitectural replay attack until the number of times each dynamic instruction is allowed to misspeculate is reached. Using the serial handle approach, an attacker is able to use multiple handles to force a finite but tangible number of replays in access of what can be achieved with a single handle.

In addition to being arranged as serial handles, multiple handles can be arranged and utilized within the ROB as nesting handles, which is illustrated in FIG. 1C. Nesting handles present certain challenges, including the fact that not all forms of speculation can be used. In some cases, e.g., page faults, misspeculation is not handled until after the processor instruction has reached the head of the ROB.

As illustrated, the nested arrangement of handles again uses a first handle 128 and a second handle 130 within the reorder buffer 132. However, the microarchitectural replay loops associated with each handle are not executed in series, but execution of the microarchitectural replay loop associated with the second handle is nested within execution of the microarchitectural replay loop associated with the first handle. Therefore, execution of the microarchitectural replay loop associated with the first handle replays execution of the microarchitectural replay loop associated with the second handle.

The first handle is stalled and execution continues including speculative execution of the side-channel instructions 134. While the first handle is stalled, the second handle is also stalled, but execution, including speculative execution of the side channel instructions continues. Upon detection of the misspeculation at the second handle, all processor instructions younger than the second handle are squashed H2 is detected, squashing all younger instructions. The second handle is then replayed 142, extending the microarchitectural replay attack until some defense is trigger, for example, the number of times each dynamic instruction is allowed to misspeculate is reached. At this point, the second handle and the speculatively execution processor instructions are released form the ROB, and misspeculation at the first handle 128 is detected. This squashes all processor instructions remaining in the ROB that are younger than the first handle. When the first handle is replayed 146, the ROB is reset with the first and second handles, providing for a new round of microarchitectural replay attacks from the second handle.

Exemplary embodiments for mitigating micro-architectural replay attacks in the processing system do not simply stop the currently known attacks but secure speculative execution from as many present and future microarchitectural replay attacks as possible. Hence, all single handle attacks, serial handle attacks and nested handle attacks are prevented.

Microarchitectural side-channel attacks leverage μ-state to leak information. The μ-states are classified into two groups, persistent μ-state and transient μ-state. Persistent μ-state remains or persists in the processing system even after the operations that caused it have finished executing. For example, data that have been installed in the cache remain there until evicted. Transient μ-state exists only while a specific operation is taking place. For example, FU contention is only observable while the FU is busy executing instructions and disappears once the FU is available again. This presents a smaller window of opportunity for the receiver to receive the information that is transmitted.

This distinction between persistent and transient μ-state affects the conditions under which the μ-state can be abused to construct a viable side-channel. Specifically, microarchitectural replay attacks exploiting persistent μ-state, especially in the cache and memory, are generally be easier to exploit and are less prone to noise. Therefore, fewer iterations may be needed for an effective attack. In one embodiment, defenses against microarchitectural replay side-channels attacks are adjusted to exploit this distinction.

In general, microarchitectural replay attacks are necessary when the side-channel used in the attack is ineffective unless it is repeated numerous times, as otherwise there would be no reason to replay the attack code, and the attacker cannot arbitrarily execute the victim code. If this was not the case, there would be no need for a microarchitectural replay attack as the attacker could simply re-execute the code as many times as necessary. Therefore, it is safe to allow a single iteration of a microarchitectural replay attack while under speculation as it will not be effective. Therefore, the question becomes how many iterations can be allowed.

In general, security is not thought of as a binary value but is treated as a multi-dimensional optimization problem, where performance, energy, and area overheads are traded-off for different levels of security guarantees. This view of security applies to the handling of side-channels. The cost of eliminating side-channels completely is enormous, while the amount of useful information that the attacker can obtain from side-channels depends on many different factors. Exemplary embodiments delay the speculative execution of processor instructions including side channel instructions upon a squash of a set of processor instructions contained in a reorder buffer, which can be referred to as Delay-on-Squash, protecting the processing system against microarchitectural replay attacks. The specifics of the how and when speculative execution is delayed and the number of replays tolerated before speculative execution is delayed are parameterized to meet the requirements of a particular processing system.

Exemplary embodiments are directed to methods for mitigating micro-architectural replay attacks in a processing system by delaying speculative execution on the processing system of a set of processor instructions upon detection that the set of processor instructions are part of a micro-architectural replay attack. In one embodiment, repeating speculative execution of the set of processor instructions interleaved with misspeculation and squashing of the set of processor instructions is detected.

In one embodiment, exemplary embodiments delay speculative instructions after a squash has been observed in the pipeline based on the observation that a single iteration of a side-channel attack will not be effective. Furthermore, the number of squashes is parameterized before actually delaying speculative instructions, as, depending on the threat model and the security guarantees that the system offers, a small number of iterations might be equally ineffective.

Not all side-channels are equal in exploitability and reliability. Similar to all transmission mediums, each side-channel has its own limitations and inherent transmission noise. Generally, side-channels based on persistent μ-state, especially ones based on the cache and memory system, are easier to exploit. Easier exploitation results because they do not always require co-location and co-execution, e.g., simultaneous multithreading, of the attacker and the victim in the same core. In addition, the state remains stable in the system for longer compared to their transient counterparts. For example, once a cache line is installed in the last level cache, the cache line remains there until evicted, which, based on the amount of activity on the system, can take a significant amount of time. Therefore, a very small number of iterations potentially could be effective in leaking sensitive information. In contrast, a side-channel such as functional unit contention is only observable at the exact moment that the computation takes place, which only lasts a few cycles, and due to its short duration is more prone to noise from other sources, thus requiring more iterations.

Therefore, in one embodiment, multiple levels of delay are utilized. For example, two levels of delay are implemented, a first level targeting only persistent cache and memory-state side-channel instructions, which can be referred to as Delay-on-Miss, and a second level targeting all side-channel instructions, which is referred to as Delay-All. Each level of delay is initiated based on a different activation threshold, i.e., a different number of squashes that are tolerated before activating the level of delay.

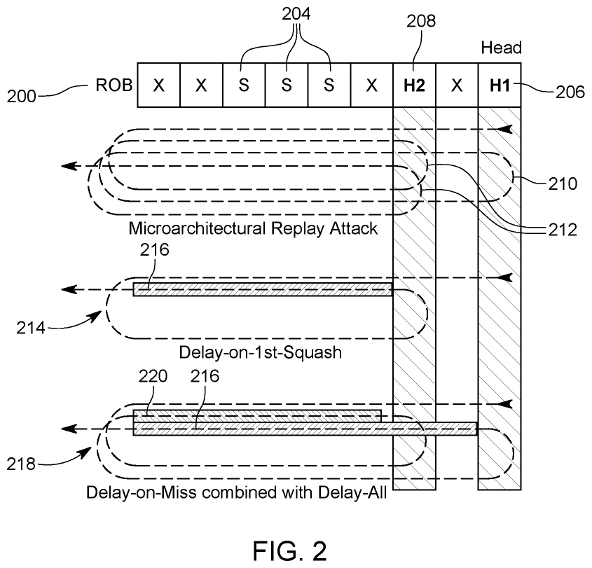

Referring now to FIG. 2, execution of an embodiment of the method for mitigating micro-architectural replay attacks in a processing system for multiple dynamic instructions operated in a nested arrangement is illustrated. A set of processor instructions including side channel instructions 204 and two dynamic instructions 206, 208 that can cause misspeculation and squashing of the set of processor instructions are stored in the reorder buffer 200. The first dynamic instruction 206 creates a first outer replay attack 210 as indicated by the dashed lines, and the second dynamic instruction creates the second, nested inner replay attacks 212. Each loop represents one side-channel iteration. FIG. 2 shows a high-level overview of a microarchitectural replay attack where the execution of a set of instructions is captured in an infinite loop.

The method for mitigating micro-architectural replay attacks in a processing system implements one or more levels of delay. In one embodiment, multiple levels of delay are implemented. An example of this one level of delay that provides a speculative defense mechanism is Delay-on-Miss, which is described by Sakalis et al. in “Efficient Invisible Speculative Execution Through Selective Delay and Value Prediction,” Proceedings of the International Symposium on Computer Architecture, ser. ISCA '19. New York, N.Y., USA: ACM, 2019, pp. 723-735. In another level, which is a much stricter speculative delay mechanism, all speculative execution or the speculative execution of all side channel instructions is delayed. This stricter speculative delay mechanism can be referred to as a Delay-All mechanism. In another level of delay, the speculative execution of instructions whose operands are speculatively accessed values or values that were generated from speculatively accessed values from the memory hierarchy is delayed, which is described by Yu et al. “Speculative taint tracking (stt) a comprehensive protection for speculatively accessed data,” Proceedings of the 52nd Annual IEEE/ACM International Symposium on Microarchitecture, 2019, and Weisse et al. “NDA: Preventing speculative execution attacks at their source,” Proceedings of the 52nd Annual IEEE/ACM International Symposium on Microarchitecture, 2019. In another level of delay, the speculative execution of instructions with memory fence or barrier instructions is delayed.

In one embodiment, the method for mitigating micro-architectural replay attacks in a processing system implements two levels of delay, a first level of delay targeting only persistent cache and memory μ-state side-channels (Delay-on-Miss) and a second level of delay targeting all side-channels (Delay-All). The second level of delay is stricter than the first level of delay. While illustrated with two levels of delay, exemplary embodiments could use three or more levels of delay. In addition, each level of delay represents a balance between security and processing system performance.

Each level of delay has a different activation threshold, i.e., a different number of squashes that are tolerated before activating the defense. For a first and second level of delay, a first threshold is used for the first level of delay, and a second threshold is used for the second level of delay. Although two levels of delay have been identified, a given implementation can use the first level of delay, the second level of delay or both the first level of delay and the second level of delay. For a Delay-on-1st-Squash 214 implementation, the first level of delay is also enabled, and the second level of delay 216 is enabled after only a single squash being detected. This provides the most conservative, i.e., fully secure, implementation. In a second implementation 218, this first level of delay 220 is enabled after a single squash, and the second level of delay 216 is enabled after two squashes are detected. This relaxes the security constraints from those used in the first implementation.

The first level of delay prevents cache and memory side-channels by delaying speculative memory instruction that can cause observable side-effects in the caches and memory. Similarly, the second level of delay prevents all side-channels by delaying all speculative instruction that can cause any observable side-effects in any part of the system. In practice, this means that processor instructions are not allowed to execute speculatively at all under the second level of delay, as any instruction can cause some form of observable microarchitectural side-effects.

Keeping track of a single unresolved dynamic instruction or handle is not sufficient when there are multiple dynamic instructions or replay handles. For microarchitectural replay attacks to function properly, all the dynamic instructions or handles have to be in the same ROB, as dynamic instructions or handles not in the ROB cannot be acquired, and side channel instructions not in the ROB will not be speculatively executed. Thus, resolution of all possible dynamic instructions in the ROB at the time of a squash establishes that the processing system is not under a possible microarchitectural replay attack. In one embodiment, a single youngest unresolved handle register is maintained that keeps track of the youngest unresolved dynamic instruction or handle in the ROB at the time of the squash. This takes advantage of a speculative shadow tracking mechanism, because the youngest shadow will not be resolved until all older shadows have also been resolved.

For the persistent μ-state, a level of delay is used that can efficiently prevent speculative instructions from causing changes in the cache and memory system. Any suitable level of delay that meets this criterion can be used as a side-channel defense. In one embodiment, the Delay-on-Miss speculative side channel defense proposed by Sakalis et al. in “Efficient Invisible Speculative Execution Through Selective Delay and Value Prediction”, Proceedings of the International Symposium on Computer Architecture, ser. ISCA '19. New York, pp. 723-735 (2019) is used. Under Delay-on-Miss, speculative memory accesses are only allowed to proceed if they hit in the private L1 cache, otherwise they are delayed until they become non-speculative. Other suitable defenses include InvisiSpec, M. Yan et al., “InvisiSpec: Making Speculative Execution Invisible in the Cache Hierarchy”, Proceedings of the ACM/IEEE International Symposium on Microarchitecture. Washington, D.C., USA: IEEE Computer Society, pp. 428-441, October 2018, and Ghost, C. Sakalis et al., “Ghost Loads: What is the Cost of Invisible Speculation?”, Proceedings of the ACM International Conference on Computing Frontiers, pp. 153-163, New York, N.Y., USA: ACM, 2019. However, exemplary embodiments are not dependent on a particular level of delay including any mechanisms specific to Delay-on-Miss.

Exemplary embodiments utilize speculative shadows to determine the earliest point at which a processor instruction and in particular a dynamic instruction or handle becomes non-speculative. The shadows are based on the insight that a processor instruction becomes non-speculative once that processor instruction cannot be squashed by another processor instruction. Any processor instruction that can cause a squash in the pipeline casts one or more shadows to all the younger processor instructions that follow it. In general, four different types of shadows are defined based on reasons why a processor instruction might be squashed, E-Shadows, which are cast by exceptions, as is the case of the page faults used in MicroScope, C-Shadows, which are cast by control flow instructions such as branches, D-Shadows, which are cast by stores with unknown addresses, as they might be modifying values of speculatively executed loads, and M-Shadows, which are cast by speculative reordering that might violate the memory model of the system. Processor instructions younger than a processor instruction casting a shadow are considered speculative and can potentially be squashed and replayed. Consequently, every shadow-casting processor instruction is a potential replay handle.

Therefore, exemplary embodiments clear a dynamic instruction by determining that a given dynamic instruction in the dynamic instructions in the reorder buffer is non-speculative. In one embodiment, this is accomplished using shadows by determining that the given dynamic instruction cannot cause misspeculation and squashing of any other processor instruction in the set of processor instructions and that the given dynamic instruction cannot be squashed by any other dynamic instruction in the reorder buffer. Other suitable methods for determining that a dynamic instruction is non-speculative, other than using the speculative shadows, include, but are not limited to, using the head and tail of the ROB.

For the persistent μ-state, a solution that can efficiently prevent speculative instructions from causing changes in the cache and memory system is used. A number of existing side-channel defenses meet this criterion. In one embodiment, the Delay-on-Miss speculative side-channel defense proposed in Sakalis et al., “Efficient Invisible Speculative Execution Through Selective Delay and Value Prediction”, Proceedings of the International Symposium on Computer Architecture, ser. ISCA '19, New York, N.Y., pp. 723-735, is used. Under Delay-on-Miss, speculative memory accesses are only allowed to proceed if they hit in the private L1 cache, otherwise they are delayed until they become non-speculative. Other suitable side-channel defenses include, but are not limited to, InvisiSpec, M. Yan et al., “InvisiSpec: Making Speculative Execution Invisible in the Cache Hierarchy”, Proceedings of the ACM/IEEE International Symposium on Microarchitecture, Washington, D.C., USA: IEEE Computer Society, October 2018, pp. 428-441, and Ghost loads, C. Sakalis et al., “Ghost Loads: What is the Cost of Invisible Speculation?”, Proceedings of the ACM International Conference on Computing Frontiers. New York, N.Y., USA: ACM, 2019, pp. 153-163. Delay-on-Squash does not depend on any mechanisms specific to Delay-on-Miss.

In order to determine if the predetermined threshold numbers of quashes are achieved, a counter is used to track of the number of squashes. Once a misspeculation is detected and a squash is triggered, the counter is incremented, and the counter is compared to the predetermined threshold values for activating one or more of the levels or delay. In addition, the youngest unresolved handle register is updated. In one embodiment, the youngest unresolved handle register is updated if the current youngest handle, i.e., the current youngest shadow-casting instruction in the reorder buffer is younger than the youngest handle currently in the youngest unresolved handle register. Therefore, the protection window is extended with each consecutive squash. The counter is cleared when all of the mitigations are lifted, i.e., when the execution has passed the youngest handle or youngest shadow of any database.

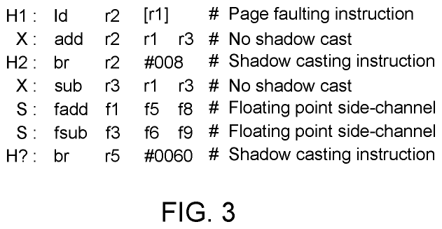

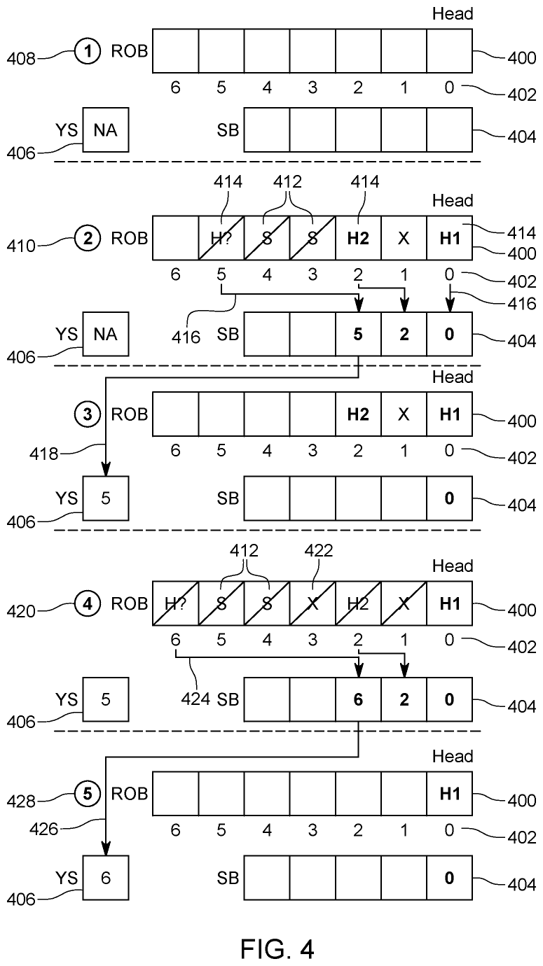

Referring to FIG. 3, an exemplary embodiment of a computer program code that includes two processor instructions that are dynamic instructions or handles H1 and H2 is illustrated. As illustrated, the first handle, H1, is a load causing page faults, and the second handle, H2, is a simple branch. Referring to FIG. 4, an exemplary embodiment of a method for mitigating micro-architectural replay attacks in a processing system using the computer program code as illustrated in FIG. 3 is illustrated. In this embodiment, speculative execution on the processing system of a set of processor instructions is delayed based on two different levels of delay upon detection that the set of processor instructions are part of a micro-architectural replay attack. In this embodiment, a single squash is allowed, and the youngest shadow or youngest unresolved handle associated with the youngest shadow is tracked. A handle queue is used to store the location of dynamic processor instructions or handles in the reorder buffer. As these handles are also associated with shadows, the handle queue is also referred to as the shadow buffer. The handle queue or shadow buffer is used to track the youngest unresolved handle and populate a youngest unresolved handle register.

A reorder buffer 400 is maintained that includes a plurality of positions. Each position has an associated dynamic instance of a unique program counter 402. A handle queue or shadow buffer 404 and a youngest unresolved handle register 406 are also maintained. Initially, the reorder buffer and the handle queue are empty 408. The value of the youngest unresolved handle register is initially set to “NA” as no shadows exist.

In general, the program counter (PC) is used for storing instructions in the database and can be used to identify this instruction and later delay it regardless of a particular iteration of a replay loop. All new instances of the same instruction are delayed. As described herein, the youngest dynamic instruction is used to disengage the mitigations, e.g., by clearing the database containing PCs. Therefore, how far the program has reached in the “execution” of the program needs to be tracked to enforce the mitigations up to that point. In one embodiment, the PC of a static instruction of a given static instruction is referred to. Alternatively, a uniquely identified “dynamic instance” of a static instruction out all the dynamic instances of the same static instruction that are currently in the ROB, for example, the third dynamic instance of a given static instruction that corresponds to the first instruction of the third iteration of the loop. Therefore, exemplary embodiments track the youngest dynamic instruction. There are multiple ways known and available in the art to identify unique dynamic instances of the same static instruction. In one embodiment, a monotonically increasing dynamic-instruction sequence-counter is formed, so each dynamic instruction effectively gets its own unique ID, until the counter wraps around to its smallest value. In one embodiment, a combination of the ROB position and the static PC is used, where the combination is appropriately enhanced with additional information to avoid aliasing with other dynamic instructions. As used here, program counter is understood to include both static instructions in the reorder buffer and a given dynamic instance of the static instruction out all the dynamic instances of the same static instruction that are currently in the ROB.

Processor instructions are fetched and inserted into the ROB 410. Therefore, the ROB includes a set of processor instructions. In general, a processor instruction is any instruction that can be executed by a processor including, for example, instructions from a computer program executing on a computing system or processor system. Suitable processor instructions in the set of processor instructions include, but are not limited to, side channel instructions 412 and dynamic instructions 414 that can cause misspeculation and squashing of one or more processor instructions in the set of processor instructions. The dynamic instructions are also referred to as handles and include loads and branches. When placed into the ROB, each processor instruction in the set of processor instructions has an associated unique program counter in the reorder buffer.

The processor instructions in the set of processor instructions are inspected and the dynamic processor instructions 414 are identified. The program counter or ROB index of each dynamic instruction, i.e., those processor instructions that cast a shadow, is entered into the handle queue 416.

A threshold number of squashes of the set processor instructions before initiating a given level of delay in speculative execution of the set of processor instructions is identified. Suitable thresholds include zero, one, two three or more. A single threshold values can be assigned for all levels of delay, or each level of delay can have a unique associated threshold. For example, a first threshold is identified for a first level of delay, and a second threshold is identified for a second level of delay. The second level of delay is stricter than the first level of delay. For example, the first threshold can be zero or one, and the second threshold can be one, two or three. In one embodiment, the second threshold is greater than the first threshold. In one embodiment, the first level of delay delays only persistent microarchitectural state side channel instructions, and the second level of delay delays all side channel instructions. In general, the thresholds are determined based on the number of iterations or loops of a microarchitectural replay attack required to achieve a successful attack. The threshold is set to a value less than that number of iterations.

A counter is maintained that contains the number of squashes of the set of processor instructions that have occurred. When a new misspeculation and squashing of the set of processor instructions is identified, the counter is incremented. The current value of the counter is compared with the identified thresholds, and a given level of delay in the speculative execution of the set of processor instructions, i.e., a given defense to microarchitectural replay attacks, is initiated when the counter is equal to or greater than the threshold associated with that given level of delay. In one embodiment for two levels of delay, a first level of delay is initiated when the value of the counter is equal to or greater than the first threshold and less than the second threshold, and the second level of delay is initiated when the counter is equal to or greater than the second threshold.

As illustrated in FIG. 4, the branch associated with the second dynamic instruction, H2, is taken causing the processing instruction following the branch to be skipped and instead the two side-channel instructions 412 (S) are fetched and executed followed by the final shadow casting instruction (H?). At this point the second dynamic instruction, branch (H2), is resolved and identified as being mispredicted. This would cause the processor instructions after the second dynamic instruction to be squashed, however, the youngest unresolved counter register is updated upon detection of the squash. Therefore, the program counter from the tail of the handle queue, which is associated with the youngest dynamic instruction in the ROB, is copied from the handle queue to the youngest unresolved handle register 418.

Execution continues from the second dynamic instruction, H2, 420, which is now on the correct path resulting in a new processor instruction 422, X, being executed before the two side-channel instructions, 412, (S) and the final dynamic instruction or shadow casting instruction (H?). Insertion of the new processor instruction into the ROB changes the program counters associated with processor instructions located in the ROB after the second dynamic instruction. The final dynamic instruction is now associated with the program counter value of 6, and the handle queue is updated to include the current program counter 424.

The page fault is then assumed to be resolved. Before the processor instructions in the ROB are squashed, the program counter in the tail of the handle queue, which is associated with the youngest unresolved handle, i.e., 6, is compared to program counter currently stored in the youngest unresolved handle register, i.e., 5, and is determined to be larger (i.e., associated with a younger position in the ROB). Therefore, the larger value is copied to the youngest unresolved handle register 426. While the same processor instruction, H?, was associated with two different program counters, the same processor instruction appeared later in the ROB the second time due to different execution paths causing the youngest unresolved handle register to be updated. With a squashing threshold of one, the speculation is now disabled, and all instructions are executed non-speculatively (i.e., in order) until the instructions in ROB index 6 and below are safely retired 428.

As described herein, shadows are used to determine when a given dynamic instruction is non-speculative and can be retired. A given dynamic instruction in the dynamic instructions in the reorder buffer is determined to be non-speculative by determining that the given dynamic instruction cannot cause misspeculation and squashing of any other processor instruction in the set of processor instructions and that the given dynamic instruction cannot be squashed by any other dynamic instruction in the reorder buffer.

In another embodiment of a method for mitigating micro-architectural replay attacks in a processing system, speculative execution on the processing system of a set of processor instructions area again delayed upon detection that the set of processor instructions are part of a micro-architectural replay attack. Detection of a micro-architectural replay attack includes detecting repeating speculative execution of the set of processor instructions interleaved with misspeculation or misprediction and squashing of the set of processor instructions. However, instead of using threshold values for the number of squashes and different levels or types of delay based the be used for a given threshold values, processor instructions that have been issued, squashed, and re-issued are tracked and processing instructions that have been issued, squashed due to a dynamic instruction that can cause misspeculation and squashing of the set of processor instructions, i.e., a replay handle, and then re-appear in the pipeline, are not allowed to be re-issued, as it might constitute part of a microarchitectural replay attack.

Again, a reorder buffer as described herein is maintained. The reorder buffer includes the set of processor instructions, which includes, for example, one or more side channel instructions and one or more dynamic instructions or handles that can cause misspeculation and squashing of the set of processor instructions. These dynamic instructions include load and branches. Each processor instruction in the set of processor instructions is associated with a unique program counter in the reorder buffer. A handle queue is also maintained, and the program counter for each dynamic instruction is loaded into and maintained in a handle queue.

When processor instructions in the reorder buffer are speculatively executed and then squashed, the set of processor instructions in the reorder buffer will include squashed processor instructions. These instructions are tracked. Therefore, to delay speculative execution the program counters for the squashed processor instructions in the reorder buffer are stored in at least one squashed processor instruction database. To reduce the size of the squashed processor instruction database, in one embodiment, hash values of the program counters are stored in squashed processor instruction database. In one embodiment, the squashed processor instruction database is a Bloom filter. Suitable hash functions and Bloom filters are discussed herein.

In addition to using a single squashed processor instruction database, multiple squashed processor instruction databases can be used. In one embodiment, program counters for the squashed processor instructions in two squashed processor instruction databases. At a given time one squashed processor instruction database is designated as an active squashed processor instruction database, and one squashed processor instruction database is designated as an inactive squashed processor instruction database. Upon detection of an additional squash, program counters associated with squashed processor instructions in the additional squash are inserted into the active squashed processor instruction database. The squashed processor instruction databases can be switched between the active squashed processor instruction database and the inactive squashed processor instruction database periodically.

Each squashed processor instruction database is tagged with a youngest dynamic instruction from the reorder buffer at a time when the program counters are stored. Therefore, upon detection of squashed instructions, the reorder buffer is checked, and the youngest dynamic instruction, e.g., the dynamic instruction with the highest program counter, is identified. This dynamic instruction is then associated with the squashed processor instruction database. Each time a given squashed processor instruction database is updated to include additional squashed instructions, the youngest dynamic instruction associated with the given squashed processor instruction database is also updated to contain the youngest dynamic instruction at that time. The youngest dynamic instruction is then used to confirm that all older dynamic instructions have been resolved before the squashed processor instruction database is cleared. Therefore, the program counters in a given squashed processor database are cleared no earlier than a resolution of a speculative status of all dynamic instructions in the reorder buffer older than the youngest dynamic instruction tagging the given active squashed processor database to non-speculative status. Only processor instructions not contained in the squashed processor instruction database are executed. The processor instructions contained in the squashed processor instruction database are delayed, which prevents a microarchitectural replay attack. Only once the processor instructions are cleared from the squashed processor instruction database, which occurs after all the dynamic instructions up to the youngest dynamic instruction are resolved.

In this embodiment, the type of delay is also considered a Delay-on-Squash and is based on the principle that if an instruction is issued, then squashed due to a replay handle, and then re-appears in the pipeline, it is not allowed to be re-issued, as it might constitute part of a microarchitectural replay attack.

To keep track of instructions that have been issued, squashed, and re-issued under the same dynamic instruction or handle, all dynamic instructions, which represent potential handles, are tracked in the ROB. Due to the serial and nested uses of dynamic instructions as discussed herein, all the dynamic instructions that affect each squashed instruction are tracked and not just the dynamic instruction that caused the last squash. To track all the dynamic instructions or handles, a first-in-first-out (FIFO) queue where all the dynamic instructions that can cause misspeculation and squashing are inserted during dispatch. While in the queue, these instructions are considered as potential handles and, by definition, are considered as “unsafe.” Dynamic instructions can only be removed from the head of the queue and only if it can be determined that they are “safe,” i.e., that they can no longer act as a handle, which happens only when they have moved outside the window of speculation. Dynamic instructions move outside the window of speculation when the instructions are ready to be committed. As the queue is a FIFO, and handles can only be removed from the head of the queue, for a handle to become safe all the older handles need to also become safe. This prevents the serial and nested replay patterns discussed herein.

With the queue of potential handles, squashed processor instructions are tracked on a per-handle basis. Every time a misspeculation occurs and instructions are squashed, the program counter from the reorder buffer for all the instructions that have been issued and are now being squashed are recorded. The youngest dynamic instruction or handle, in ROB order, is retrieved from the queue and is associated to the squashed program counters. These program counters remain stored until their corresponding youngest handle is determined to be safe, i.e., until the handle is removed from the handle queue. Using the youngest handle, instead of the actual misspeculating processor instruction that caused the squash, prevents the use of a nested replay pattern.

By storing the PCs of the squashed instructions until the youngest (at the point of the squash) handle is safe, the record of the squashed PCs remain stored until all the handles that were present in the window of speculation during the squash have left the window and are thus safe. With this guarantee, these records before are checked before issuing a processor instruction. If the program counter for a processor instruction matches one of the program counters stored records, the processor instruction associated with that program counter was previously issued and squashed and that the dynamic instructions or handles that preceded that processor instruction are still in the ROB and are still considered unsafe. Such processor instructions are prevented from being issued until the relevant handles are deemed to be safe and the records are removed. To prevent interference from other contexts, this information is stored and restored on a context switch, much like the rest of the execution state (e.g., registers).

With this mechanism in place, when an instruction has been issued, squashed, and then re-issued can be constantly detected, even for complex cases, such as when the attacker might be utilizing nested handles. Iterations of the computer program or processor code are detected and prevented, instantly stopping any microarchitectural replay attacks.

The pattern of “issue, squash, and re-issue” can also happen under normal speculative execution, i.e., when not under attack, for example, when a load is squashed due to a memory order violation, as in such cases the execution path remains the same. In addition, if a loop is executing that is small enough to fit several loop iterations in the window of speculation, a squash in one of them will cause all the iterations that follow (within the window) to be delayed, as the instructions at each iteration all share the same program counter.

While this embodiment can be implemented as an actual hardware solution, this would require large storage and expensive content addressable memories for keeping exact sets of squashed program counters, leading to prohibitively large area, latency, and energy overheads. In one embodiment, hash functions and in particular Bloom filters are used to represent the sets of program counters of squashed instructions that are temporarily prevented from being issued speculatively. Suitable Bloom filters are discussed in B. H. Bloom, “Space/Time Trade-Offs in Hash Coding with Allowable Errors”, Communications of the ACM, vol. 13, no. 7, p. 422-426, July 1970, the entire contents of which is incorporated herein by reference. Using hash functions and Bloom filters facilitates storing the PCs of tens of squashed instructions with only a few bits of storage.

In one embodiment, the Bloom filters are hash-based, probabilistic data structures used to test if an element, e.g., a PC, is part of a set. The element is hashed with a number of hash functions, each of which indicates a position in the filter that has to be set to “one”. While it is possible to get a false positive when checking the filter, it is not possible to get a false negative. False negatives lead to unsafe replay iterations. False positives, on the other hand, only manifest as reduced opportunities for speculation, which would cause a negligible performance overhead. Different implementations of Bloom filters can be used.

In one embodiment, to implement Bloom filters, the simplest, most efficient form of binary Bloom filters is used, where the only way of erasing elements from the filter is to clear the whole filter by bulk-resetting. Other approaches could be used but come at increased overheads without significant performance benefits. In one embodiment, all the hash functions of the PC of a particular dynamic instruction are precomputed during dispatch and kept in the ROB entry of that particular dynamic instruction. Following a squash, the precomputed hash functions are used to index the Bloom filter and set the corresponding “ones” in parallel with multiple other ROB entries. In one embodiment, the whole process is hidden behind the back-end recovery latency following a squash.

In one embodiment, for each squash, each set of squashed PCs is associated with a dynamic instruction or handle. In a replay attack, the set of PCs hardly changes from squash to squash. Maintaining the same redundant information across multiple Bloom filters is, therefore, a waste of resources. In one embodiment, the information is maintained in a single rolling Bloom filter spanning several squashes. The single rolling Bloom filter holds all the PCs of all the squashed instructions. For each squash, the PCs associated with the squashed processor instruction are added to the Bloom filter. The updated Bloom filter is then associated with the youngest handle in existence in the handle queue at the time of the squash and update. This maintains all the information required to delay the speculative execution of processor instructions and prevent replay attacks.

However, clearing of the Bloom filter can be difficult. Exemplary embodiments utilize a simple binary Bloom filter, and individual instructions cannot be erased from the simple binary Bloom filter. In addition, only the youngest handle is associated with the Bloom filter as it is not possible to remove individual PCs. When the handle associated with the Bloom filter, i.e., the youngest handle, leaves the window of speculation and becomes safe, the processor instructions associated with all PCs in the Bloom filter are safe, and the Bloom filter is cleared. Since the Bloom filter is associated with the youngest handle during each squash, the lifetime of the Bloom filter can be extended an arbitrary number of times and the clearing can be deferred for an arbitrarily long time.

Therefore, in one embodiment, multiple Bloom filters are used, for example, a cyclical list of several Bloom filters, out of which one is active and the others are inactive. In one embodiment, two rolling Bloom filters are used and are switched between periodically. At a given time, one of the Bloom filters is designated as active, and the other Bloom Filter is inactive, waiting to be cleared. Following a squash, the PCs of the squashed instructions are inserted in the currently active Bloom filter, and the active Bloom filter is associated with current the youngest handle. At this point, the inactive Bloom filter is waiting for its associated handle to leave the window of speculation to facilitate clearing the inactive Bloom filter using a bulk-reset. When the inactive Bloom filter is cleared, then the inactive Bloom filter is switched to be the active Bloom filter, and the active Bloom filter is switched to the inactive Bloom filter to wait for the conditions that allow it to be cleared. Any processor instruction that is to be issued is checked against the contents of all squashed instruction databased, e.g., both Bloom filters, active and the inactive, to determine whether the processor instruction can be issued safely. In one embodiment, more than two squashed instruction databases or Bloom filters are used. For example, a cyclical list of several Bloom filters is used with one active Bloom filter and a plurality of inactive Bloom filters.

The Bloom filters are context-specific, i.e., each execution context has its own set of filters, which is securely stored and reloaded on a context switch. This prevents other contexts, including the OS, from saturating or otherwise manipulating the method for delaying execution of speculative processor instructions.

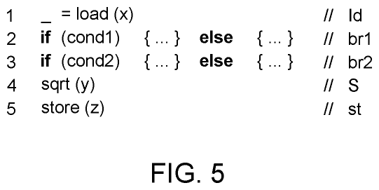

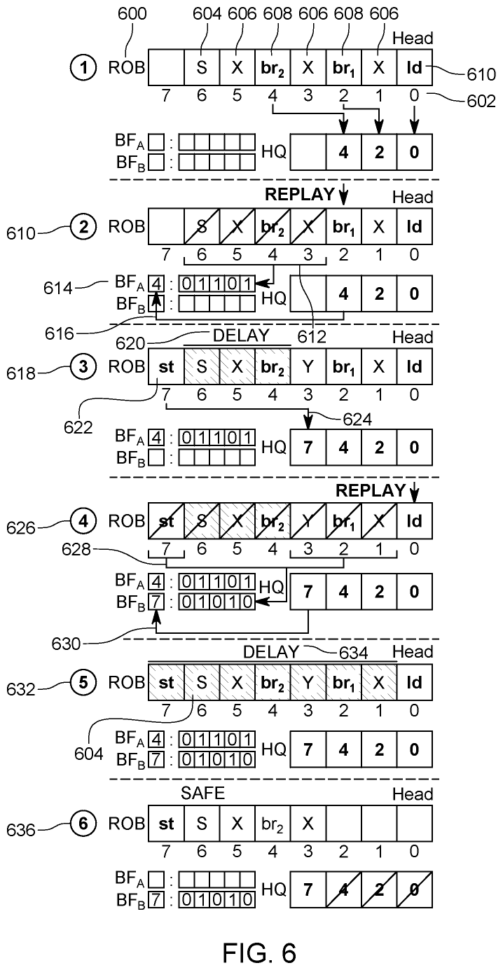

Referring to FIG. 5, an exemplary code is illustrated that can be used with squashed instruction databases and in particular Bloom filters to mitigate micro-architectural replay attacks. Referring to FIG. 6, a step-by-step example of a method for delaying the speculative execution of processor instructions to not allowing squashed processor instructions from being re-issued, Delay-on-Squash, by tracking handles and using squashed instruction databases or Bloom filters.

The reorder buffer 600 is maintained, and the set of processor instructions are loaded into the reorder buffer in order and associated with program counters 602. The set of processor instructions include side channel instructions 604, dynamic instructions including branch instructions 608 and a load instruction 610, and other processor instructions 606.

In the illustrated embodiment, the attacker intends to launch a nested attacked that first uses the branch instructions br₁ and br₂ sequentially (one replay for each) and then uses the load instruction Id to squash everything and re-use the same branch instructions br₁ and br₂. Branched instructions cannot be used more than once sequentially, as once a branch is executed the correct target becomes known. However, when the attacker triggers the Id handle, it is possible to re-train the branch predictor, as the victim will be stalled while the page fault is being handled. Dynamic instructions or handles based on page faults have to always be the outermost handle, as page faults are not handled speculatively, unlike branch-based handles, which are speculated early in the pipeline. The same processor instructions are illustrated being squashed and fetched many times, as showing how instructions are tracked when the execution diverges between squashes (as is usually the case with branch mispredictions) would make the example overly complicated.

A handle queue is also maintained. The dynamic instructions in the reorder buffer are identified, and the program counters associated with those dynamic instructions are loaded into the handle queue. The attacker setup the microarchitectural state so that the first branch instruction, br₁, (which is mispredicted) is resolved first 610. This is achieved by manipulating the branch predictor and other microarchitectural states on which the branch condition, e.g., cached cache lines, depends. When the misprediction or misspeculation is detected, the instructions that follow br₁ are squashed. These squashed instructions are tracked by loading them into the squashed instruction database, e.g., a Bloom filter. At this point, the reorder buffer contains squashed processor instructions. These squashed instructions are tracked by loading them into the squashed instruction database, e.g., a Bloom filter. The program counters associated with the squashed processor instructions are inserted into the active Bloom filter 612, which is BF_{A} 614. The active Bloom filter is tagged with the program counter for youngest potential handle 616, which is the program counter for the second branch instruction, br₂.

Execution restarts from the squashed branch 618, with the squashed processor instructions delayed. The instructions in the reconvergent path are once again dispatched in the ROB. The PCs 620 that have been seen before, i.e., the ones that hit in the Bloom filters, are delayed. Therefore, the side channel instruction, S, is prevented from being replayed. In this example, a new dynamic instruction 622, st, is also dispatch. The new dynamic instruction is added to the handle queue 624, where is becomes the youngest potential handle.

The second branch instruction, br₂, is used as a sequential handle (not shown). Since the second branch instruction, br₂, has already been squashed once, it is prevented from being issued and further used as a handle. For the nested portion of the microarchitectural replay attack 626, the load page dynamic instruction, Id, faults, and execution of all processor instructions in the reorder buffer is squashed. Therefore, all issued instructions are added to the Bloom filter. Assume that a second Bloom filter, BF_{B}, has been switched to be the active Bloom filter. Therefore, the program counters associated with the squashed instructions, and in particular the squashed instructions that we not previously squashed and track in the first Bloom filter, BF_{A}, are placed into the second Bloom filter 628. The second Bloom filter is tagged with the program counter for the youngest potential handle 630, which at this time is the program counter associated with the new dynamic instruction, st.

When execution resumes 632, all instructions that have been seen before 634 are, once again, delayed. This includes the side-channel instruction 604, S, whose program counter still stored in the first Bloom filter, BF_{A}. Once all the older handles (Id, br₁, and br₂) have been resolved 636, the first Bloom filter, BF_{A} is cleared, and the side-channel processor instruction 604, S, is executed. As illustrated, the second branch processor instruction, br₂, has not yet been retired, and removed from the reorder buffer. However, the second branch processor instructions are considered resolved once that processor instruction has been executed and has been verified as having not been mispredicted.

For simplicity, the load processor instruction, Id, is shown as remaining in the ROB when squashed, but in practice loads that page fault are typically squashed and re-dispatched. In some cases, e.g., on a context switch, it is possible that after squashing the handle queue is left empty, as all instructions are either squashed or otherwise deemed safe. In those cases, a corner case is run where the Bloom filters are cleared before the squashed handles, e.g., br₁, have been re-introduced into the window of speculation, enabling the attacker to perform several replay iterations. Such cases are handled conservatively by delaying the clearing of the Bloom filters by the length of the dynamic instruction window, which is the longest window for any handles to be re-introduced.

In one embodiment, dynamic instructions or handles are considered safe when they reach the head of the ROB and are retired. Preferably, as discussed herein dynamic instructions or handles are consider as safe when they can no longer cause squashing, regardless of their position in the ROB. Specifically, the approach of using speculative shadows as a mechanism for detecting the earliest point at which an instruction is no longer speculative is adopted as discussed in C. Sakalis et al., “Understanding Selective Delay as a Method for Efficient Secure Speculative Execution”, IEEE Transactions on Computers, vol. 69, no. 11, pp. 1584-1595, (2020), C. Sakalis at al., “Ghost Loads: What is the Cost of Invisible Speculation?”, Proceedings of the ACM International Conference on Computing Frontiers, New York, N.Y., pp. 153-163 (2019), and C. Sakalis et al., “Efficient Invisible Speculative Execution Through Selective Delay and Value Prediction”, Proceedings of the International Symposium on Computer Architecture, ser. ISCA '19, pp. 723-735 (2019), the entire disclosures of which are incorporated herein by reference. While these shadows are configured to work with speculative side-channel defences, which do not necessarily work against microarchitectural replay attacks, the underlying principle can be used.

According to the method, any speculative instruction that can cause squashing is referred to as a “shadow-casting” instruction. Depending on the type of speculation, four different types of shadows are defined, E-Shadows, C-Shadows, D-Shadows and M-Shadows. However, this list can be extended to include other types of speculation as well, such as the transactional memory case. Once a processing instruction is no longer shadowed by another processor instruction and no longer casts any shadows itself, i.e., when there is no reason for said processor instruction to be squashed, the processor instruction is considered non-speculative. At this point, the processor instruction has left the window of speculation and, assuming that the processor instruction was a potential handle, is considered safe. This approach makes it possible for potential handles to reach the safe state earlier than simply waiting for the handles to retire.

C. Sakalis et al. in “Efficient Invisible Speculative Execution Through Selective Delay and Value Prediction” also describe a hardware implementation to track speculation based on a FIFO queue, where younger shadow-casting instructions are only resolved once all older shadow-casting instructions have also been resolved. Exemplary embodiments apply a similar arrangement to the handle queue or shadow buffer, as the handle queue has similar characteristics. Using the speculative shadows, however, is not necessary, and the use of alternative methods is possible, e.g., using the head and tail of the ROB.

Delaying the executing of processor instructions following squash as described herein targets microarchitectural replay attacks, where more than one iteration is necessary to leak sensitive information. When it is possible to leak information with a single iteration of an attack, additional defense mechanisms are combined with Delay-on-Squash, for example, defences against speculative side-channel attacks.

In addition to preventing microarchitectural replay attacks, the state kept by within the method, e.g., by the Bloom filters and other portions, is isolated from other contexts and stored/restored on a context switch. This ensures that new side-channels are not introduced into the system. This prevents the attacker from manipulating the methods described herein either to “make it forget” a replayed instruction or to introduce unnecessary overheads in the victim application. At the same time, the attacker cannot in any way probe the information about the victim application, as that would allow the attacker to ascertain which instructions the victim has executed. These conditions are enforced by the hardware by isolating the mechanism between contexts and storing it in an encrypted manner on a context switch, much like the rest of the context, e.g., the register file, is already stored.

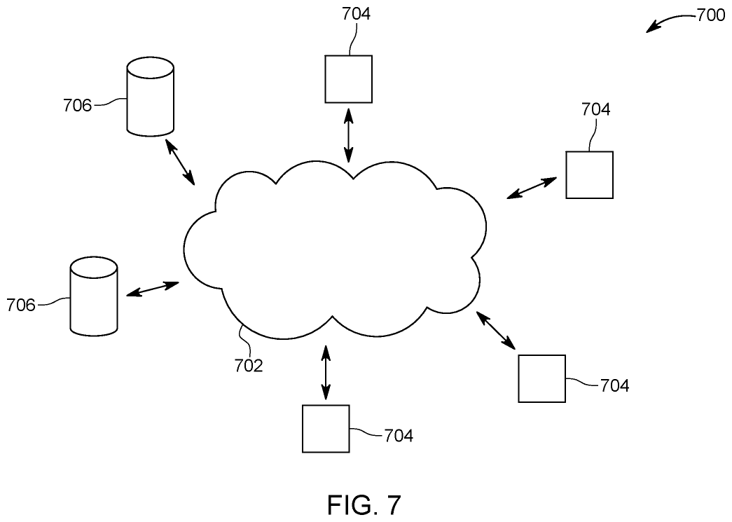

Referring now to FIG. 7, exemplary embodiments are directed to a processing system 700 capable of mitigating micro-architectural replay attacks in the processing system using any one of the methods as described herein. The processing system includes one or more memories or storage medium 706. Suitable memories and storage mediums are known and available in the art. These storage mediums include one or more databases that store the operating system instructions and computer programs that provide the processor instructions that are executed on the processor system. The memories or storage mediums can also be used to store the registers, queues, databases, bloom filters, registers and buffers utilized by the methods discussed herein.

The processing system also includes one or more processors 704 to execute processor instructions from a computer program executing on the processing system. Any suitable processor known and available in the art can be used, and includes central processor units (CPU), servers, and computers. The memories and processors can be in communication across one or more local or wide area networks 702. The processing system can be arranged as a standalone processing system or as a distributed or cloud-based processing system. In one embodiment, the processing system including the processors include other hardware, software and firmware utilized for functioning of the processing system including communication and networking components. In one embodiment, the processors can include memories systems including cache memory that provides for the registers, queues, databases, bloom filters, registers and buffers utilized by the methods discussed herein.

In one embodiment, the processing system includes a reorder buffer, and the processor can store processor instructions in and retrieve processor instructions from the reorder buffer. In one embodiment, the reorder buffer is an integral part of the processor. The reorder buffer includes a set of processor instructions, and this set of processor instructions includes side channel instructions, other types of instructions and dynamic instructions or handles that can cause misspeculation and squashing of the set of processor instructions. These handles include load instructions and branch instructions. Each processor instruction in the set of processor instructions has an associated unique program counter in the reorder buffer.

The processing system includes a handle queue in communication with the processor, for receiving the program counter for each dynamic instruction determined to be loaded in the reorder buffer. In one embodiment, the processing system includes at least one squashed processor instruction database for storing program counters for squashed processor instructions in the reorder buffer. Suitable arrangements for the at least one squashed processor instruction database are discussed herein. In one embodiment, the at least one squashed processor instruction database is a Bloom filter. In one embodiment, the processing includes two squashed processor instruction databases, for example two Bloom filters. The two squashed processor instruction databases include an active squashed processor instruction database and an inactive squashed processor instruction database. Program counters associated with processor instructions in the reorder buffer that have been squashed are inserted into and stored in the active squashed processor instruction database upon detection of a squash. The squashed processor instruction databases are switch between the active squashed processor instruction database and the inactive squashed processor instruction database periodically.

The active squashed processor database and the inactive squashed processor database each include a tag, and the tag is an identification of a dynamic instruction from the reorder buffer that represents a youngest dynamic instruction in the reorder buffer any time program counters are stored. The program counters in a given squashed processor database are cleared only upon resolution of all dynamic instructions in the reorder buffer older than the youngest dynamic instruction tagging the given active squashed processor database. The processor instructions associated with the cleared program counters are executed within the processing system. However, the processor only executes processor instructions not contained in the squashed processor instruction database to delay speculative execution on the processing system of the set of processor instructions upon detection that the set of processor instructions are part of a micro-architectural replay attack.

In another embodiment, the processing system includes the processor, reorder buffer containing the set of processor instructions, and the handle queue or shadow buffer in communication with the processor to store the program counter for each dynamic instruction loaded into the reorder buffer. In this embodiment, the processing system includes a counter for storing a number of squashes of the set of processor instructions that have occurred. The processor increments the counter upon detection of a new misspeculation and squashing of at least a portion of the set of processor instructions within the reorder buffer. The processer is configured to provide a given level of delay in the speculative execution of the set of processor instructions. The processor initiates the given level of delay when the counter is equal to or greater than a predefined threshold to delay speculative execution on the processing system of the set of processor instructions upon detection that the set of processor instructions are part of a micro-architectural replay attack.

In one embodiment, the processor is configured to initiate a first level of delay when the counter is equal to or greater than a first threshold and less than the second threshold and a second level of delay when the counter is equal to or greater than a second threshold. In one embodiment, the second threshold greater than the first threshold, and the second level of delay stricter than the first level of delay. In one embodiment, the processing system includes a youngest unresolved dynamic instruction register that stores a program counter associated with a youngest dynamic instruction in the handle queue.

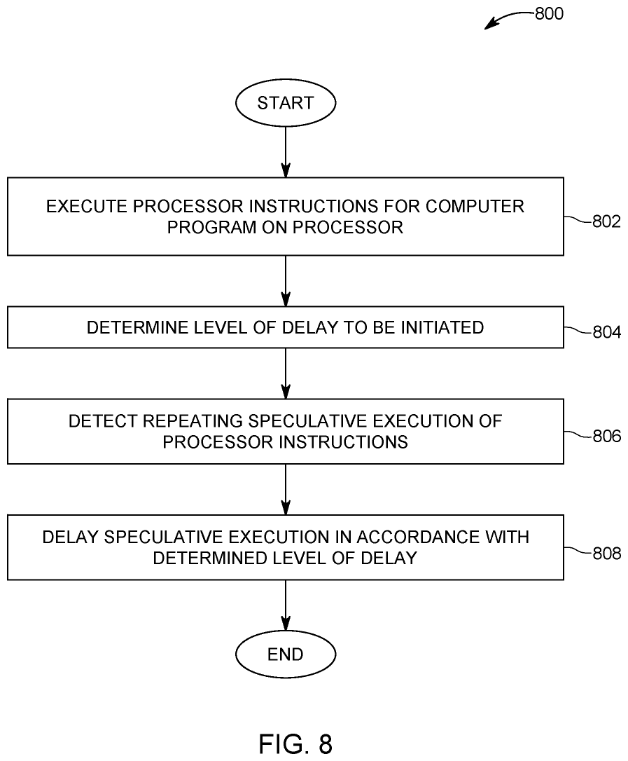

Referring now to FIG. 8, exemplary embodiments are directed to a method for mitigating micro-architectural replay attacks in a processing system 800. A set of processing instructions for a computing program executing on a computing system or processing system are executed using one or more processors contained in the computing system 802. The set of processor instructions includes side channel instructions and dynamic instructions that can cause misspeculation and squashing of the set of processor instructions. A determination is made regarding a level of delay to be initiated upon detection of a microarchitectural replay attack in the computing system 804.

Repeating speculative execution of the set of processor instructions interleaved with misspeculation and squashing of the set of processor instructions is detected 806. Based on this detection, speculative execution on the processing system of the set of processor instructions is delayed in accordance the determined level of delay 808. As repeating speculative execution indicates a microarchitectural replay attack, speculative execution is delayed upon detection that the set of processor instructions are part of a microarchitectural replay attack.

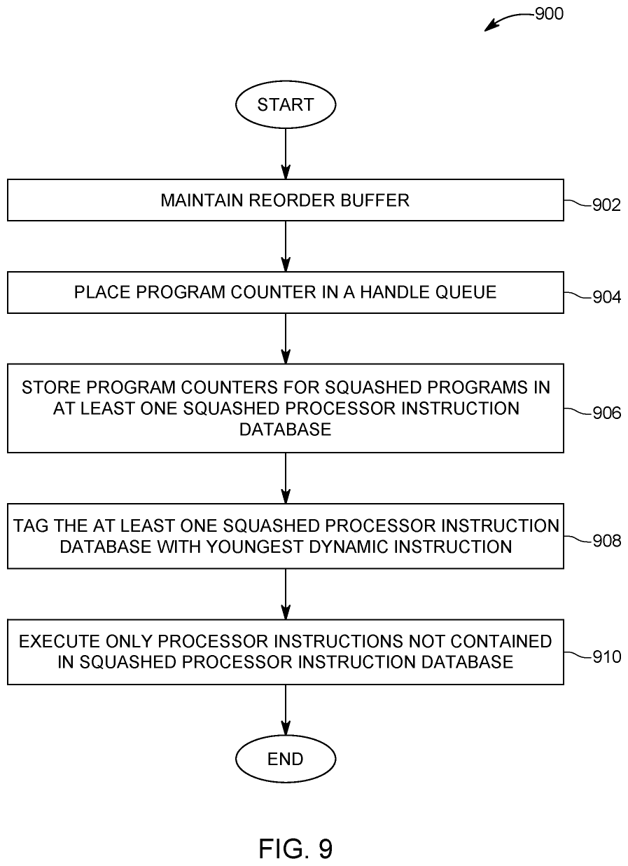

Referring to FIG. 9, an embodiment of delaying speculative execution 900 is illustrated. A reorder buffer containing the set of processor instructions from the computing program is maintained 902. The set of processor instructions include side channel instructions, dynamic instructions that can cause misspeculation and squashing of the set of processor instructions, and squashed processor instructions. Each processor instruction in the set of processor instructions has an associated unique program counter in the reorder buffer. The program counter for each dynamic instruction is placed in a handle queue 904.

Program counters for the squashed processor instructions contained in the reorder buffer are stored in at least one squashed processor instruction database 906. The at least one squashed processor instruction database is tagged with a youngest dynamic instruction from the reorder buffer at a time when the program counters are stored 908. In one embodiment, the program counters are stored as hash values of the program counters. In one embodiment, the at least one squashed processor instruction database is a Bloom filter.

In one embodiment, program counters for the squashed processor instructions are stored in a plurality of squashed processor instruction databases, for example, two squashed processor instruction databases such as two Bloom filters. At a given time, one squashed processor instruction database is designated as an active squashed processor instruction database and any other squashed processor instruction databases is an inactive squashed processor instruction database. Upon each detection of an additional squash, program counters associated with squashed processor instructions in the additional squash into the active squashed processor instruction database. The squashed processor instruction databases can be switched periodically between the active squashed processor instruction database and the inactive squashed processor instruction database. This provides for clearing of the inactive squashed processor instruction database as described herein. Therefore, the program counters in a given squashed processor database are cleared no earlier than a resolution of a speculative status of all dynamic instructions in the reorder buffer older than the youngest dynamic instruction tagging the given active squashed processor database to non-speculative status. In this embodiment, only processor instructions not contained in the squashed processor instruction database are executed 910. For embodiments containing multiple squashed processor instruction databases, e.g., multiple bloom filters, only processor instructions not contained in any squashed processor instruction database are executed.

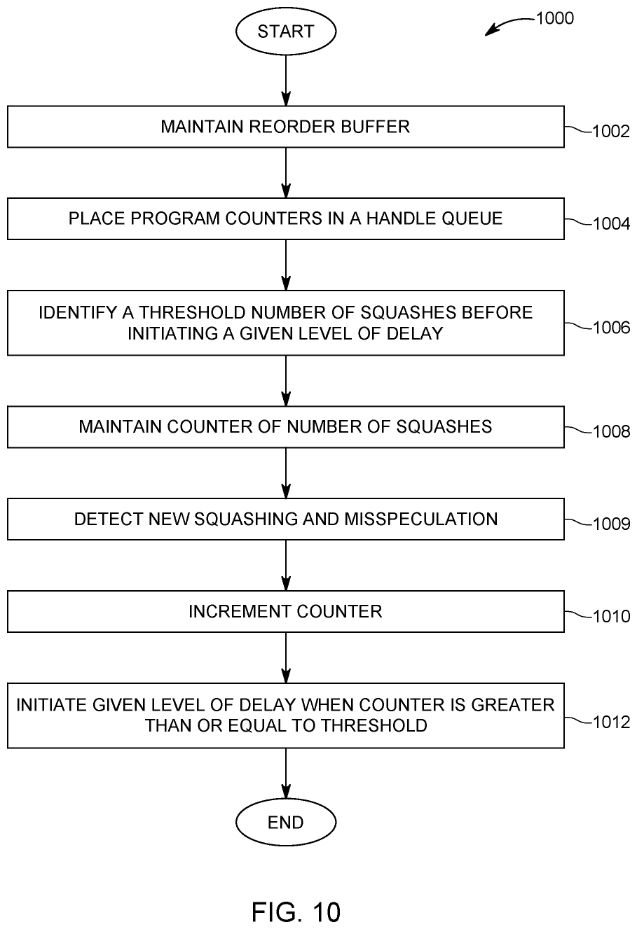

Referring to FIG. 10, another embodiment of delaying speculative execution 1000 is illustrated for another level of delay is illustrated. A reorder buffer containing the set of processor instructions from the computing program is maintained 1002. The set of processor instructions include side channel instructions, dynamic instructions that can cause misspeculation and squashing of the set of processor instructions, and squashed processor instructions. Each processor instruction in the set of processor instructions has an associated unique program counter in the reorder buffer. The program counter for each dynamic instruction is played in a handle queue 1004, which is also referred to as a shadow buffer.

A threshold number of squashes of the set processor instructions before initiating a given level of delay in speculative execution of the set of processor instructions is identified 1006, and a counter of a number of squashes of the set of processor instructions is maintained 1008. A new misspeculation and squashing of the set of processor instructions is detected 1009, and the counter is incremented 1010. The identified given level of delay in the speculative execution of the set of processor is initiated instructions when the counter is equal to or greater than the threshold 1012.

In one embodiment, a first threshold is identified for a first level of delay, and a second threshold is identified for a second level of delay. The second level of delay is stricter than the first level of delay. The first level of delay is initiated when the counter is equal to or greater than the first threshold and less than the second threshold, and the second level of delay is initiated when the counter is equal to or greater than the second threshold. In one embodiment, the first level of delay delays only persistent microarchitectural state side channel instructions, and the second level of delay delays all side channel instructions.

Exemplary embodiments of the methods and systems for mitigating micro-architectural replay attacks in processing systems described herein, provide improvement in the secure operation of processing systems, in particular processing systems are susceptible to side-channels attacks such as microarchitectural side channel attacks. In particular, exemplary embodiments balance system performance with increased security. Therefore, the effects on system performance are minimized while security against a wide range of side channel attacks is increased.

Methods and systems in accordance with exemplary embodiments of the present invention can take the form of an entirely hardware embodiment, an entirely software embodiment or an embodiment containing both hardware and software elements. In one embodiment, the invention is implemented in software, which includes but is not limited to firmware, resident software and microcode. In addition, exemplary methods and systems can take the form of a computer program product accessible from a computer-usable or computer-readable storage medium including a non-transient computer-readable storage medium providing program code for use by or in connection with a computer, logical processing unit or any instruction execution system. For the purposes of this description, a computer-usable or computer-readable medium can be any apparatus that can contain, store, communicate, propagate, or transport the program for use by or in connection with the instruction execution system, apparatus, or device. Suitable computer-usable or computer readable mediums include, but are not limited to, electronic, magnetic, optical, electromagnetic, infrared, or semiconductor systems (or apparatuses or devices) or propagation mediums. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

Suitable data processing systems for storing and/or executing program code include, but are not limited to, at least one processor coupled directly or indirectly to memory elements through a system bus. The memory elements include local memory employed during actual execution of the program code, bulk storage, and cache memories, which provide temporary storage of at least some program code in order to reduce the number of times code must be retrieved from bulk storage during execution. Input/output or I/O devices, including but not limited to keyboards, displays and pointing devices, can be coupled to the system either directly or through intervening I/O controllers. Exemplary embodiments of the methods and systems in accordance with the present invention also include network adapters coupled to the system to enable the data processing system to become coupled to other data processing systems or remote printers or storage devices through intervening private or public networks. Suitable currently available types of network adapters include, but are not limited to, modems, cable modems, DSL modems, Ethernet cards and combinations thereof.

In one embodiment, the present invention is directed to a machine-readable or computer-readable medium containing a machine-executable or computer-executable code that when read by a machine or computer causes the machine or computer to perform a method for mitigating micro-architectural replay attacks in a processing system and to the computer-executable code itself. The machine-readable or computer-readable code can be any type of code or language capable of being read and executed by the machine or computer and can be expressed in any suitable language or syntax known and available in the art including machine languages, assembler languages, higher level languages, object oriented languages and scripting languages. The computer-executable code can be stored on any suitable storage medium or database, including databases disposed within, in communication with and accessible by computer networks utilized by systems in accordance with the present invention and can be executed on any suitable hardware platform as are known and available in the art including the control systems used to control the presentations of the present invention.

It should be understood that this description is not intended to limit the invention. On the contrary, the exemplary embodiments are intended to cover alternatives, modifications and equivalents, which are included in the spirit and scope of the invention. Further, in the detailed description of the exemplary embodiments, numerous specific details are set forth in order to provide a comprehensive understanding of the invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a general purpose computer or a processor.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for mitigating micro-architectural replay attacks in a processing system, the method comprising delaying speculative execution on the processing system of a set of processor instructions upon detection that the set of processor instructions are part of a micro-architectural replay attack.

2. The method of claim 1, wherein the method further comprises detecting repeating speculative execution of the set of processor instructions interleaved with misspeculation and squashing of the set of processor instructions.

3. The method of claim 1, wherein the set of processor instructions comprise side channel instructions.

4. The method of claim 1, wherein delaying speculative execution further comprises:
maintaining a reorder buffer comprising the set of processor instructions, the set of processor instructions comprising side channel instructions and dynamic instructions that can cause misspeculation and squashing of the set of processor instructions, each processor instruction in the set of processor instructions comprising an associated unique program counter in the reorder buffer; and
placing the program counter for each dynamic instruction in a handle queue.

5. The method of claim 4, wherein:
the set of processor instructions in the reorder buffer comprises squashed processor instructions; and
delaying speculative execution further comprises:
storing program counters for the squashed processor instructions in at least one squashed processor instruction database; and
tagging the at least one squashed processor instruction database with a youngest dynamic instruction from the reorder buffer at a time when the program counters are stored.

6. The method of claim 5, wherein storing the program counters comprises storing hash values of the program counters.

7. The method of claim 5, wherein the at least one squashed processor instruction database comprises a Bloom filter.

8. The method of claim 5, wherein storing program counters for the squashed processor instructions further comprises:
storing program counters for the squashed processor instructions in two squashed processor instruction databases;
designating at a given time one squashed processor instruction database as an active squashed processor instruction database and one squashed processor instruction database as an inactive squashed processor instruction database;
inserting, upon detection of an additional squash, program counters associated with squashed processor instructions in the additional squash into the active squashed processor instruction database; and
switching the squashed processor instruction databases between the active squashed processor instruction database and the inactive squashed processor instruction database periodically.

9. The method of claim 8, wherein storing program counters for the squashed processor instructions further comprises clearing the program counters in a given squashed processor database no earlier than a resolution of a speculative status of all dynamic instructions in the reorder buffer older than the youngest dynamic instruction tagging the given active squashed processor database to non-speculative status.

10. The method of claim 5, wherein the method further comprises only executing processor instructions not contained in any squashed processor instruction database.

11. The method of claim 4, wherein delaying speculative execution further comprises:
identifying a threshold number of squashes of the set processor instructions before initiating a given level of delay in speculative execution of the set of processor instructions;
maintaining a counter of a number of squashes of the set of processor instructions;
detecting a new misspeculation and squashing of the set of processor instructions;
incrementing the counter; and
initiating the given level of delay in the speculative execution of the set of processor instructions when the counter is equal to or greater than the threshold.

12. The method of claim 11, wherein:
identifying the threshold number of squashes comprises:
identifying a first threshold for a first level of delay; and
identifying a second threshold for a second level of delay, the second level of delay stricter than the first level of delay; and
initiating the given level of delay further comprises:
initiating a first level of delay when the counter is equal to or greater than the first threshold and less than the second threshold; and
initiating the second level of delay when the counter is equal to or greater than the second threshold;
wherein the first level of delay delays only persistent microarchitectural state side channel instructions, and the second level of delay delays all side channel instructions.

13. The method of claim 5, wherein delaying speculative execution further comprises determining that a given dynamic instruction in the dynamic instructions in the reorder buffer is non-speculative by determining that the given dynamic instruction cannot cause misspeculation and squashing of any other processor instruction in the set of processor instructions and that the given dynamic instruction cannot be squashed by any other dynamic instruction in the reorder buffer.

14. A processing system capable of mitigating micro-architectural replay attacks in the processing system, the processing system comprising:
a processor to execute processor instructions from a computer program executing on the processing system;
a reorder buffer, the reorder buffer comprising a set of processor instructions, the set of processor instructions comprising side channel instructions and dynamic instructions that can cause misspeculation and squashing of the set of processor instructions, each processor instruction in the set of processor instructions comprising an associated unique program counter in the reorder buffer;
a handle queue in communication with the processor, the handle queue comprising the program counter for each dynamic instruction in the reorder buffer; and
at least one squashed processor instruction database for storing program counters for squashed processor instructions in the reorder buffer;
wherein the processor only executes processor instructions not contained in the squashed processor instruction database to delay speculative execution on the processing system of the set of processor instructions upon detection that the set of processor instructions are part of a micro-architectural replay attack.

15. The processing system of claim 14, wherein the at least one squashed processor instruction database comprises a Bloom filter.

16. The processing system of claim 14, further comprising two squashed processor instruction databases, the two squashed processor instruction databases comprising:
an active squashed processor instruction database; and
an inactive squashed processor instruction database, program counters associated with processor instructions in the reorder buffer that have been squashed are inserted into the active squashed processor instruction database upon detection of a squash;
wherein the squashed processor instruction databases are switch between the active squashed processor instruction database and the inactive squashed processor instruction database periodically.

17. The processing system of claim 16, wherein:
the active squashed processor database and the inactive squashed processor database are each tagged with a dynamic instruction from the reorder buffer representing a youngest dynamic instruction in the reorder buffer any time program counters are stored;
the program counters in a given squashed processor database are cleared no earlier than a resolution of a speculative status of all dynamic instructions in the reorder buffer older than the youngest dynamic instruction tagging the given active squashed processor database to non-speculative status; and
the processor instructions associated with the cleared program counters are executed.

18. A processing system capable of mitigating micro-architectural replay attacks in the processing system, the processing system comprising:
a processor to execute processor instructions from a computer program executing on the processing system;
a reorder buffer, the reorder buffer comprising a set of processor instructions, the set of processor instructions comprising side channel instructions and dynamic instructions that can cause misspeculation and squashing of the set of processor instructions, each processor instruction in the set of processor instructions comprising an associated unique program counter in the reorder buffer;
a handle queue in communication with the processor, the handle queue comprising the program counter for each dynamic instruction in the reorder buffer; and
a counter containing a number of squashes of the set of processor instructions that have occurred, the counter incremented upon detection of a new misspeculation and squashing of the set of processor instructions;
wherein a given level of delay in the speculative execution of the set of processor instructions is initiated when the counter is equal to or greater than a predefined threshold to delay speculative execution on the processing system of the set of processor instructions upon detection that the set of processor instructions are part of a micro-architectural replay attack.

19. The processing system of claim 18, wherein a first level of delay is initiated when the counter is equal to or greater than a first threshold and less than the second threshold and a second level of delay is initiated when the counter is equal to or greater than a second threshold, the second threshold greater than the first threshold and the second level of delay stricter than the first level of delay.

20. The processing system of claim 18, wherein the processing system further comprises a youngest unresolved dynamic instruction register comprising a uniquely identifying dynamic instance of the program counter associated with a youngest dynamic instruction in the handle queue.
